(19) United States
(12) Patent Application Publication
(10) Pub. No.: US 2010/0089130 A1
(43) Pub. Date: Apr. 15, 2010

(54) Method of testing a nozzle connection

(76) Inventor: William J. Koves, Hoffman Estates, IL (US)

Correspondence Address: Meroni & Meroni, P.C., P.O. Box 309, Barrington, IL, 60011, US

(21) Appl. No.: 12/287,804

(22) Filed: Oct. 14, 2008

(51) Int. Cl. G01M 3/28

(52) U.S. Cl. 73/49.8

(57) ABSTRACT

A nozzle testing method involves testing a nozzle connection via pressurized fluid. The nozzle is subjected to both circumferential and axial tension the magnitude of which is approximately equal to that achieved in a full system pressure test. The method isolates and pressure tests a nozzle in a vessel or pipe by using a device that is inserted from the outside of the nozzle to be tested, although for some applications a restraining head may be placed from the inside of the vessel. The test devices supporting the method are capable of reacting the axial pressure thrust force with a structural member or fluid pressure bearing on the external surface of a vessel or alternatively internal to the vessel or pipe bearing on the opposite wall of the pipe or vessel. The stresses applied to the nozzle neck and attaching weld are primary stresses due to the applied pressure.

### BACKGROUND OF THE INVENTION

1. Field of the Invention

The present invention generally relates to a method for testing a nozzle connection, and more particularly to certain nozzle testing methods whereby the target nozzle is subjected to both circumferential and axial tension the magnitude of which is approximately equal to that achieved in a full system pressure test.

2. Description of the Prior Art

U.S. Pat. No. 2,581,536 ('536 Patent), which issued to Johns, discloses a Self-Sealing Test Plug. The '536 Patent describes a self-sealing test plug comprising a housing member having a closed end, a reciprocating member in the housing member forming therewith an inner chamber, a transversely disposed sealing element on one member adapted to engage in sealing contact with a rim of an aperture in a vessel to be tested, an anchoring means comprising a stem secured to the other of said members and an anchor head secured to said stem adapted to be extended into the aperture for engagement with the inner surface of said vessel, and a passage communicating between the chamber and the interior of said vessel.

U.S. Pat. No. 3,451,432 ('432 Patent), which issued to Miller, discloses certain Test Plug Means for Fluid Conduits. The '432 Patent describes certain plug means for removably closing an access opening through which a measuring instrument may be inserted within a fluid conduit. In the preferred embodiment, the test plug means includes a synthetic plastic housing adapted for mounting across an opening contained in a conduit, and a plug removably mounted in a through bore in the housing to afford test access to the conduit, said housing having a frustoconical portion extending outwardly from the conduit opening to protect and attractively conceal a corresponding beveled surface of the access opening contained in a layer of insulation that jackets the conduit.

U.S. Pat. No. 3,483,894 ('894 Patent), which issued to Finocchiaro, discloses a High Pressure Pipe Test Plug. The '894 Patent describes pipe test plugs and in particular test plugs employed at extremely high liquid pressures wherein the plug must be secured therein and yet permit the introduction of liquid therethrough at said high pressures. Essentially these plugs serve to confine within a pipe, liquid which is fed into the pipe via plug itself. Certain of the structures disclosed in this patent would likely bear on the issue of patentability.

U.S. Pat. No. 3,618,811 ('811 Patent), which issued to Martino, discloses a Releasable Fluid Seal or Test Plug for Conduits. The '811 Patent describes a releaseable fluid seal for conduits or pipes having a cylinder of an elastomeric resilient material fitting into the pipe or conduit. The cylinder has a conical internal surface. A truncated conical plate fits in the cylinder and a bolt extends from the plate through an open end of the cylinder. A second plate engages the periphery of the open end of the cylinder and also engages the end of the conduit or pipe or engages in the bell of the pipe. A wing nut on the bolt draws the two plates toward each other and bows the cylinder into fluid tight sealing engagement with the inner wall of the conduit or pipe. An externally threaded hollow tube passing through the conical plate may be used in place of the bolt when the seal is to be used as a test plug.

U.S. Pat. No. 4,381,800 ('800 Patent), which issued to Leslie, discloses a Pipe Tester Plug. The '800 Patent describes a high pressure pipe tester plug for insertion into a pipe having a joint such as a weld to be tested includes a stem terminating in a fixed tapered washer, a plurality of grip segments arranged about the stem, an annular floating mandrel positioned about the stem and having an upper retaining section, a cylindrical section and a tapered entry section, an O-ring positioned in an internal recess of the floating mandrel and a ring-shaped seal, rectangular in cross section, positioned about the cylindrical section of the floating mandrel and retained by the upper retaining section. When tightened by a nut, the floating mandrel is forced into the top end of the grip segments, the washer is forced into the bottom end of the grip segments and the ring-shaped seal engages the pipe interior to isolate the joint to be tested.

U.S. Pat. No. 4,393,674 ('674 Patent), which issued to Rasmussen, discloses a Hydraulic Chuck Device for Engagement with the Inside of a Tube. The '674 Patent describes a hydraulic chuck device with a body defining a chamber and a piston slideably mounted in said chamber. An axially centered stem means is mounted at one of its end on said piston and has a passage along its axis, while sleeve means slideably cover said stem means and are mounted on said body. Collet means are operably connected to said stem means and said sleeve means such that relative movement of one with respect to the other causes activation of said collets. First fluid means are connected to said piston to cause relative movement between said stem and said sleeve, and second fluid means are connected to said stem means for passage of fluid through said passage of said stem means into the inside of said tube. In a preferred embodiment said first means is a pneumatic means positioned to move said piston in said chamber, from a first position blocking passage of fluid from said second fluid means to a second position permitting passage of fluid into said passage, whereby said collets are activated in said second position. The second fluid means preferably has associated herewith an auxiliary chamber communicating with said piston in said second position to permit fluid pressure to further urge said piston to said second position. In a preferred embodiment, collet engaging means are mounted on said stem and collet surface activating means are on said sleeve to cooperatively activate the collets. Seal means are preferably supplied to engage the inside of said tube when said collets are engaged.

U.S. Pat. No. 6,367,313 ('313 Patent), which issued to Lubyk, discloses a Test Plug. The Test Plug of the '313 Patent includes a blind flange for mating with a pipe flange, a compression mandrel having a conical recess, an expander having a conical surface which mates with the compression mandrel and an elastomeric annular seal positioned between the compression mandrel and the expander. Removeable compression rings of different sizes may be attached to the test plugs and used with different sizes of annular seals. The expander is actuated by a rod which extends through the compression mandrel and to the exterior of the test plug. Installation of the test plug isolates and seals an end portion of the pipe. Fluid under pressure may then be pumped into the isolated segment to test for pressure integrity.

U.S. Pat. No. 6,675,634 ('634 Patent), which issued to Bemeski, Jr. et al., discloses a Branch Pipe/Tank Nozzle Test Plug and Method of Use. The '634 Patent describes a test plug and method for isolating and testing a connection, such as a welded connection, which interconnects a wall of tank, vessel, or pipe to a branch pipe or nozzle. The test plug isolates the connection from the remainder of the tank, vessel or piping system and enables pressure/leak testing of the connection without requiring pressurization of the entire tank or vessel or a large section of the piping system. Further, the test plug can be utilized during welding operations to isolate harmful materials, vapors or fumes existing within tanks, vessels or piping systems from the weld location and to permit the flow of an inert gas to safely flush any potentially harmful vapors or the like away from the welding area.

United States Patent Application Publication No. 2007/0248202, which was authored by Carson et al., discloses a Weld Testing Apparatus and Method for Nozzles. This publication essentially describes a weld testing assembly for testing the integrity of weld used to secure a nozzle to a vessel and the like comprises a pair of plates or discs positioned on either end of the nozzle and a generally coaxially extending annular body having a diameter smaller than the nozzle stem. The assembly creates a sealed area with a small volume whereby a weld test can be efficiently conducted.

This disclosure describes a nozzle testing apparatus and method in which the embodiment shown in FIG. 2 is essentially a modification of the FIG. 1 device otherwise shown in Canadian Patent No. 2,223,247, which issued to Carson et al. The device (shown in FIG. 2 of U.S. Patent Application Publication No. 2007/0248202) provides a hole in the nozzle so that a two-man crew with one man on the outside of the vessel and one man on the inside of the vessel can communicate. The axial stress in the nozzle is compressive. The technical and/or methodological aspects of the Carson et al. pressure test were state of the art and thus not novel or at the very least, obvious.

The prior art thus perceives a need for certain nozzle testing equipment and methodology whereby access to the inside of the vessel is no longer required. The prior art also states the need for pressure testing the nozzle connection without requiring pressurization of the entire tank or vessel or a large section of the piping system. Chemical plant personnel, for example, often experience the need to repair or replace components at their facilities. Pressure testing may be required by the applicable codes or jurisdictional authority.

The costs for pressure testing the entire vessel or piping system could be in excess of a million dollars per day due to the additional time required for a full system test. Thus, there is a need in the industry to have low cost procedures supporting the repair, alteration, or replacement of components such that overall operating costs can be maintained at a minimum, and, for safety and jurisdictional requirements, subject the nozzle to approximately the same pressure induced stresses as during a full system pressure test.

### SUMMARY OF THE INVENTION

Accordingly, the present invention attempts to structurally address the foregoing concerns and thus provides a method of locally testing nozzle or branch connections involving testing using a fluid (liquid or gas) by certain means whereby the nozzle is subjected to hoop (circumferential) tension and axial tension the magnitude of which is approximately equal to that achieved in a full system pressure test. The method also allows for testing without requiring entry to the vessel.

In other words, the present invention is directed to such a method and/or apparatus for accomplishing this result. The novelty of this idea is that the axial pressure thrust is reacted with an adjustable piece or component that reacts it into the wall of the vessel or pipe and thereby tension can be placed on the nozzle neck. This tensile stress essentially operates to enable a tester to check the integrity of weld due to the hydrostatic pressure. State of the art testing equipment or devices place components under compressive forces and so state of the art equipment or devices are not properly testing welds.

To achieve these and other readily apparent objectives, the present invention provides a method of isolating and pressure testing a nozzle in a vessel or pipe by using a device that is inserted from the outside of the nozzle to be tested, although for some applications a pressure restraining head may be placed from the inside of the vessel.

The test device has the capability for reacting the axial pressure thrust force with a structural member or fluid pressure bearing on the external surface to a vessel or pipe or alternatively internal to the vessel or pipe bearing on the opposite wall of the pipe or vessel. The test device also internally pressurizes the nozzle developing a hoop (circumferential) tension stress in the nozzle neck equal to that achieved in a full system pressure test. The stresses applied to the nozzle neck and attaching weld are primary stresses due to the applied pressure.

The common elements of the invention regardless of structural detail, are as follows: (1) the nozzle to be tested is internally pressurized; (2) the nozzle neck is subjected to a primary membrane circumferential (hoop) stress approximately equal to (P D)/(2t); (3) the nozzle neck is subjected to a primary membrane axial force approximately equal to P(π/4)D²; and (4) the axial pressure thrust force P(π/4)D² is reacted by the vessel (pipe) shell.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is a depiction of a first conventional or prior art pressure test tool apparatus otherwise more fully described as FIG. 2 in Canadian Patent No. 2,223,247.

FIG. 1(a) is a first free body diagram of a first portion of the prior art test tool apparatus otherwise depicted in FIG. 1.

FIG. 1(b) is a second free body diagram of a second portion of the prior art test tool apparatus otherwise depicted in FIG. 1.

FIG. 2 is a depiction of a second conventional or prior art pressure test tool apparatus as developed by Superior Plant Services.

FIG. 2(a) is an enlarged, fragmentary sectional view as taken from FIG. 2 at the barrel-to-vessel interface.

FIG. 2(b) is a free body diagram of the prior art test tool apparatus otherwise depicted in FIG. 2.

FIG. 3 is a first structural configuration of a test tool for supporting the methodology according to the present invention.

FIG. 3(a) is a free body diagram of an upper portion of the structural configuration otherwise depicted in FIG. 3.

FIG. 3(b) is a free body diagram of an alternative construction of the lower portion of the structural configuration otherwise depicted in FIG. 3.

FIG. 3(c) is a fragmentary depiction of a preferred construction of the lower portion of the structural configuration otherwise depicted in FIG. 3.

FIG. 3(d) is a top plan view of the pressure thrusting plate otherwise depicted in FIG. 3(c).

FIG. 3(e) is a fragmentary arc length section of the extending arm structure otherwise depicted in FIG. 3(c).

FIG. 3(f) is a fragmentary arc length section of the seal plate structure otherwise depicted in FIG. 3(c).

FIG. 4 is a second structural configuration of a test tool for supporting the methodology according to the present invention.

FIG. 4(a) is a free body diagram of a first portion of the structural configuration otherwise depicted in FIG. 4.

FIG. 4(b) is a free body diagram of a second portion of the structural configuration otherwise depicted in FIG. 4.

FIG. 4(c) is a free body diagram of a third portion of the structural configuration otherwise depicted in FIG. 4.

FIG. 5 is a third structural configuration of a test tool for supporting the methodology according to the present invention.

FIG. 5(a) is a free body diagram of a first portion of the structural configuration otherwise depicted in FIG. 5.

FIG. 5(b) is a free body diagram of addressing a second portion of the structural configuration otherwise depicted in FIG. 5.

FIG. 6 is a fourth structural configuration of a test tool for supporting the methodology according to the present invention.

FIG. 6(a) is a free body diagram of a first portion of the structural configuration otherwise depicted in FIG. 6.

FIG. 6(b) is a free body diagram of a second portion of the structural configuration otherwise depicted in FIG. 6.

FIG. 6(c) is an alternative embodiment to the structural configuration otherwise depicted in FIG. 6 having a first free body diagram of a first portion thereof.

FIG. 6(d) is a second free body diagram of structures otherwise depicted in FIG. 6(c).

FIG. 7 is a depiction of a third conventional or prior art pressure test tool apparatus otherwise more fully described as FIG. 2 in U.S. Patent Application Publication No. 2007/0248202.

FIG. 7(a) is a first free body diagram of a first portion of the prior art test tool apparatus otherwise depicted in FIG. 7.

FIG. 7(b) is a second free body diagram of a second portion of the prior art test tool apparatus otherwise depicted in FIG. 7.

FIG. 8 is a depiction of an alternative embodiment of the third prior art pressure test tool apparatus otherwise more fully described as FIG. 12 in U.S. Patent Application Publication No. 2007/0248202.

### DETAILED DESCRIPTION OF THE PREFERRED METHODOLOGY

Referring now to the drawings with more specificity, the following nomenclature applies to the following description and attached figures.

| F_{N} (as at 101) = | Total axial force in nozzle neck |
|---|---|
| F_{R} (as at 100) = | Total axial force in restraining rod |
| P (as at 102) = | Internal test pressure |
| D (as at 103) = | Nozzle inside diameter |
| Dₒ (as at 105) = | Nozzle outside diameter |
| D_{S} (as at 106) = | Structural Frame or Cylindrical Housing inside |
| | diameter |
| d (as at 104) = | Restraining rod outside diameter See note (1). |
| F_{G} (as at 107) = | Reaction force at gasket (seal) location |
| G (as at 108) = | Gasket (seal) diameter |
| F_{B} (as at 109) = | Structural bolt force |
| F_{S} (as at 110) = | Total axial force in the structure |
| (200) = | Free Body Boundary (ies) |

Notes:
(1) Multiple restraining rods may be used. In the case of multiple restraining rods “d” = the diameter of a single rod that results in the same total cross sectional area as the multiple rods.
(2) For all of the above axial forces there are two values, one for the initial assembly condition and one when the internal test pressure is applied. A superscript “i” will represent the initial assembly condition (eg. Fⱼⁱ). The force Fⱼ (j = N, R, G, B, S) without superscript represents the total force during the pressure test.

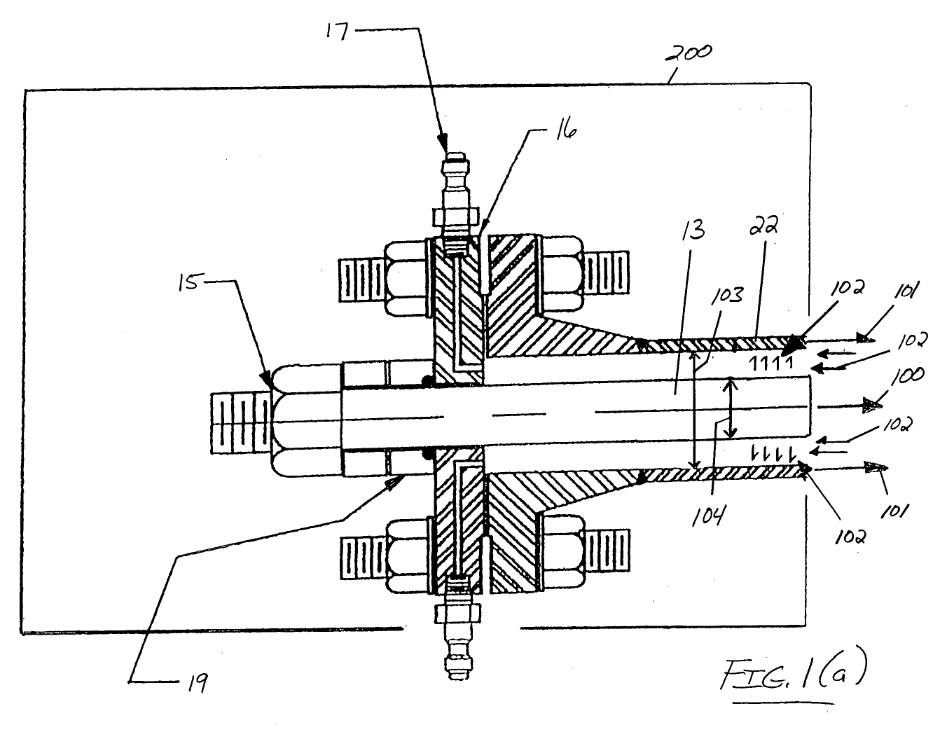

FIG. 1 depicts a prior art test tool designed by G. J. Berube and G. Carson, and is otherwise illustrated and described in Canadian Patent No. 2,223,247, which patent is based upon International Patent Application No. PCT/CA99/00859. Canadian Patent No. 2,223,247 is assigned to Car-Ber Investments, Inc. of Canada. FIGS. 1(a) and 1(b) are respective free body diagrams of the left or first and right or second portions FIG. 1 test tool design.

Referencing FIG. 1, the test tool may be said to operate in combination with a vessel wall as indicated at 10 and a weld cap as indicated at 11. A nut 12 is seal-welded to a vessel end of the restraining stud or restraining rod 13 and weld cap 11. The weld cap 11 comprises a vent 14. An O-ring seal 20 interfaces between the vessel wall 10 and the cap 11. Opposite the vessel end of the stud or rod 13 is a nut 15. A cylindrical nozzle neck 22 generally surrounds the length of the rod 13. A manufactured flange joint 16 retains a fluid pressure monitoring port as at 17 and a fluid supply port as at 18. A packing gland with O-ring seal is generally depicted and referenced at 19.

Referring to FIG. 1(a), the free body boundary is referenced at 200; the total axial force in the restraining rod 13 “F_{R}” is referenced at vector 100; the total axial force in the nozzle neck 22 “F_{N}” is referenced at vector 101; and the internal test pressure “P” is referenced at vectors 102. The nozzle inside diameter “D” is referenced at 103 and the restraining rod outside diameter “d” is referenced at 104. At equilibrium, the resulting force relation may be represented, as follows:

F_{N}+F_{R}=(P)(π/4)(D²−d²).

Referring to FIG. 1(b), the free body boundary is referenced at 200; the reaction force at the gasket seal location “F_{G}” is referenced at vector 107; the total axial force in the restraining rod 13 “F_{R}” is again referenced at vector 100; and the internal test pressure “P” is referenced at vectors 102. The gasket seal diameter “G” is referenced at 108, and the restraining rod outside diameter “d” is referenced at 104. At equilibrium, the resulting force relation may be represented, as follows:

F_{R}−F_{G}=(P)(π/4)(G²−d²).

For the initial assembly condition the restraining rod 13 is conventionally tightened to achieve a force at least equal to the axial pressure thrust force during the pressure test. In the assembly of bolted flange joint 16 it is conventional to tighten to much higher loads because of possible relaxation of the joint 16. Similarly, rod 13 would be tightened to a higher force to maintain a seal at gasket 20.

### Therefore:

F_{R}ⁱ=X(P)(π/4)(G²−d²), where X is a factor greater than 1.0.

Referring to FIG. 1(b),

F_{G}ⁱ=F_{R}ⁱ.

During pressurization the force system is redundant in that the change in F_{R} and F_{G} as pressure is applied is a function of the relative stiffness of the load path for gasket 20 and the restraining rod 13. If metal to metal contact is achieved at the O-ring seal location it is reasonable, and conservative from a fluid sealing aspect, to assume that all of the pressure thrust load (−(P)(π/4)(G²−d²)) goes into reducing the gasket sealing load.

### Therefore

F_{G}=F_{G}ⁱ+change in gasket load=(X−1)(P)(π/4)(G²−d²).

Equilibrium requires that

F_{R}−F_{G}=P(π/4)(G²−d²).

Therefore,

F_{R}=F_{G}+P(π/4)(G²−d²)=(X−1)(P)(π/4)(G²−d²)+P(π/4)(G²−d²)

F_{R}=X(P)(π/4)(G²−d²).

From FIG. 1(a),

F_{N}=P(π/4)(G²−d²)−F_{R}.

Therefore,

F_{N}=(1−X)(P)(π/4)(G²−d²)

Since X is a positive number greater than 1.0, F_{N} is negative vs. a positive thrust force equal to P(π/4)D² as achieved in a full system pressure test. The test tool design in illustrated in FIG. 1 was also analyzed in detail using Finite Element Analysis in an ASME paper published by A. Cheta and R. Brodzinski in the Journal of Pressure Vessel Technology, November 2007, vol. 129. Cheta and Brodzinski's conclusions were the same, namely, that the axial stress in the nozzle neck is compressive.

The membrane circumferential (hoop) stress in the nozzle neck 22 away from any discontinuities is equal to P D/(2 t) where “t” is the nozzle neck thickness. This is the same as in a full system pressure test. Therefore the test tool design generally illustrated in FIG. 1 is able to match the circumferential pressure stress during a full system pressure test. However, the axial stress, which is applied to the weld joining the nozzle type test tool and vessel 10 (pipe) is compressive and not tensile as required.

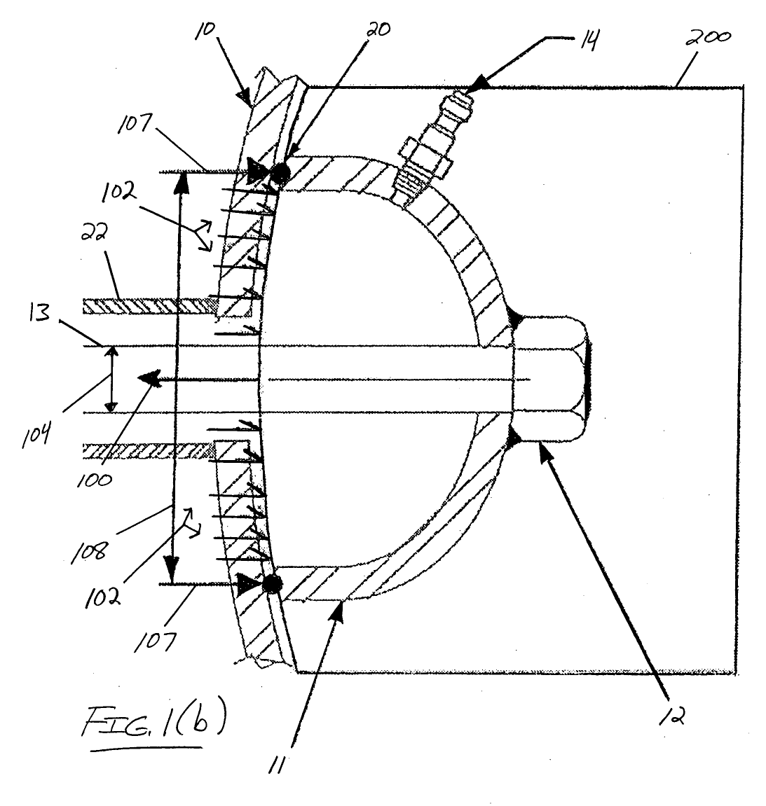

FIG. 2 generally illustrates a second prior art nozzle test operation as designed by Superior Plant Services. FIG. 2(a) is an enlarged section of the barrel-to-vessel interface depicting an O-ring type seal as at 70. An outer barrel or cylindrical housing is referenced at 24; a second compressible O-seal type seal is referenced at 72; the vessel wall is referenced at 10; and solid steel members are referenced at 73 and 74. Bolts to compress/seal the seal 72 are referenced at 23 and bolts to clamp the barrel 24 down are referenced at 76. Nuts 77 cooperate with the bolts 23 and 76 to provide fastening engagement.

FIG. 2(b) is a free body diagram of the nozzle test operative structure otherwise depicted in FIGS. 2 and 2(a) with certain structures simplified for clarity. The total axial force in the nozzle neck (78) “F_{N}” is referenced at 101; the total axial force in the structure “F_{S}” is referenced at 110; the internal test pressure is referenced at vectors 102; and the annular area (Aₐₙₙ) extending intermediate the nozzle neck 78 and the outer housing 24 is referenced at 25.

For the initial assembly condition the structural bolts 23 are tightened to achieve a compressive force in the cylindrical housing 24 at least equal to the axial pressure thrust force during the pressure test. In this case, the axial pressure thrust during the pressure test is now the pressure over the outer annulus area (as at 25) between the outside of the nozzle “Dₒ” as at 105 and the inside of the outer cylindrical housing “D_{S}” as at 106.

The total axial force in the nozzle neck (78) “F_{N}” is equal to the product of the internal test pressure “P” and the annular area (Aₐₙₙ) 25 plus the total axial force in the structure as at 110. The resulting force relation may be represented, as follows:

F_{N}=(P)(Aₐₙₙ)+F_{S}, where Aₐₙₙ=(π/4)(D_{S}²−Dₒ²)

The same discussion on assembly stress as presented for FIG. 1 applies here also. Therefore as before,

F_{S}ⁱ=X(P)(π/4)(D_{S}²−Dₒ²), where X is a factor greater than 1.0.

Also,

F_{N}ⁱ=F_{S}ⁱ

and,

F_{N}=F_{N}ⁱ+the change in F_{N} during pressurization.

The gasket (seal) location “F_{S}” is referenced at 110 and as before the load will decrease by the pressure thrust, such that

F_{S}=F_{S}ⁱ+change in load during pressurization=(X−1)(P)(π/4)D_{S}²−Dₒ²).

F_{N}=F_{S}+(P)(π/4)(D_{S}²−Dₒ²)=X(P)(π/4)(D_{S}²−Dₒ²).

Since the desired axial thrust force during the pressure test is P(π/4)D², the outer annulus area 25 must be sized to give the desired force. The preload and annular thrust force could actually apply a stress greater than desired and yield the nozzle. There will be a high degree of variability in the preload force, because it is a controlled displacement vs. a controlled load.

The membrane circumferential (hoop) stress in the nozzle neck 78 away from any discontinuities is equal to −P Dₒ/(2 t) where “t” is the nozzle neck thickness. This stress is compressive and opposite as in a full system pressure test. Therefore the design generally illustrated in FIG. 2 is not able to match the circumferential pressure stress during a full system pressure test.

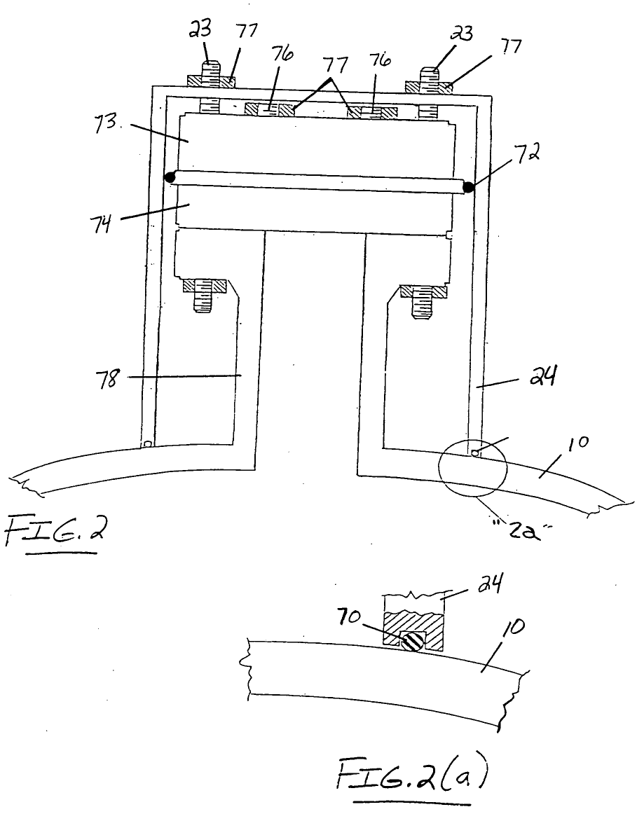

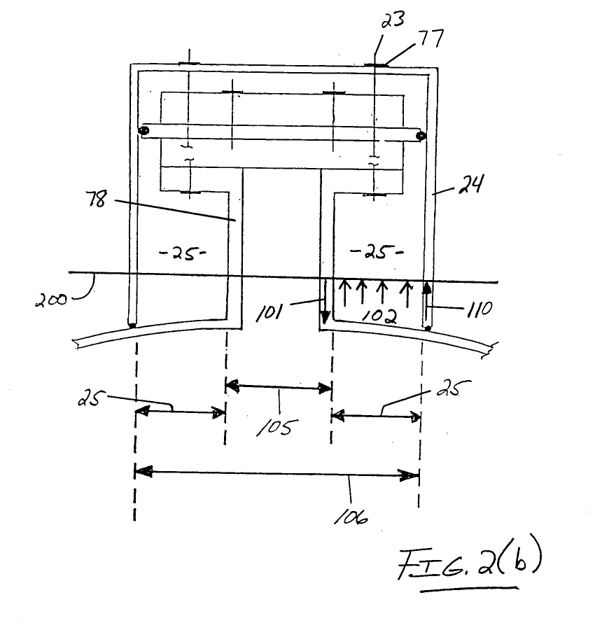

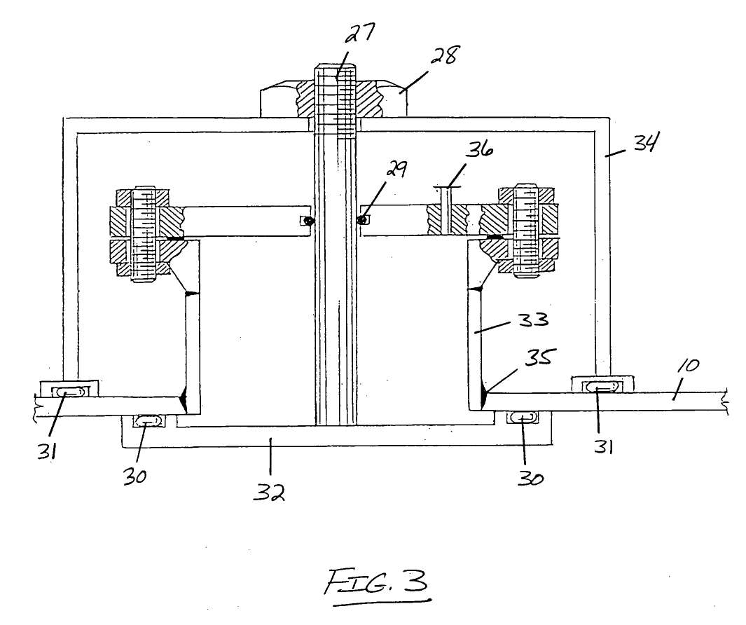

FIGS. 3(c), 3(a), and 3(b) are free body diagrams of the test tool design otherwise generally depicted in FIG. 3. FIG. 3(a) is an upper or first diagram of the device otherwise shown in FIG. 3 and FIG. 3(c) illustrates a preferred lower or second diagram of the device otherwise shown in FIG. 3. FIG. 3(b) is an alternative lower configuration of the device otherwise shown in FIG. 3.

The apparatus generally illustrated in FIG. 3 comprises pressure connection(s) 36, structural frame 34, restraining rod 27, and nut 28, pressure thrust restraining head 32 with seals 30 and 29 contained in a blind flange. The seal at 29 is conceivably any means that will maintain a pressure seal and provide minimal axial restraint. An O-ring type seal is generally illustrated at 29 in FIG. 3.

The seal at 30 could be an O-ring or inflatable bladder. Optionally, the bladder pressure of the inflatable bladder as at 30 could be controlled and measured during the test. An optional inflatable bladder 31 (located at the housing-vessel interface) could be used to hydraulically preload seal 30 versus tightening nut 28. The pressure thrust restraining head 32 (of any suitable pressure-containing shape) is further illustrated and referenced.

FIG. 3(c) illustrates a preferred construction showing a pressure thrust restraining head that may be installed by insertion from the outside of the vessel. The pressure thrust restraining head comprises a main body as at 32a, seal plates as at 32b, extending arms as at 32c, a gasket as at 32d, and bolts as at 32e.

The outside diameter of body 32a, identified as 103a in FIG. 3(d) is less than the inside nozzle diameter “D” and inserted into the nozzle with gasket 32d and seal at 30. Extending arms 32c, as shown in FIG. 3(e) are next inserted into the groove in body 32a. The gasket 32d and seal 30 are next placed in position. Finally, the seal plates 32b as shown in FIG. 3(f) are bolted in position using bolts 32e. The seal plates 32b and gasket 32d seal the gaps between the extending arms 32c.

Referencing FIG. 3(a), the free body boundary is referenced at 200; the total axial force in the nozzle neck (33) “F_{N}” is referenced at 101; the total axial force in the restraining rod (27) “F_{R}” is referenced at 100; and the total axial force in the structure “F_{S}” is referenced at 110. The internal test pressure “P” is referenced at vectors 102; the nozzle insider diameter “D” is referenced at 103; and the restraining rod outside diameter “d” is referenced at 104. The resulting equilibrium relation may be represented, as follows:

F_{N}+F_{R}−F_{S}−(P)(π/4)(D²−d²)=F_{R}−F_{S}, and therefore,

F_{N}=(P)(π/4)(D²−d²)

Referencing FIG. 3(b), the free body boundary is referenced at 200; the total axial force in the restraining rod (27) “F_{R}” is referenced at 100; the total reaction force at the gasket seal location “F_{G}” is referenced at 107; and the internal test pressure “P” is referenced at vectors 102; the gasket seal diameter “G” is referenced at 108. The resulting equilibrium relation may be represented, as follows:

F_{G}+(P)(π/4)(G²−d²)=F_{R}

For the initial assembly condition the restraining rod 27 is conventionally tightened via a nut 28 to achieve a force at least equal to the axial pressure thrust force during the pressure test. Therefore,

F_{R}ⁱ=X(P)(π/4)(G²−d²), where X is a factor greater than 1.0.

Referring to FIG. 3(b) for the initial condition with no pressure, F_{G}ⁱ=F_{R}ⁱ. This produces an equal axial force in the outer structural frame 34. Referring to a cut in the apparatus at section A-A in FIG. 3(a):

F_{S}ⁱ=F_{R}ⁱ and F_{S}=F_{R}

F_{G}=F_{G}ⁱ+change in load during pressurization=(X−1)(P)(π/4)(G²−d²)

From FIG. 3(b),

F_{R}=F_{G}+(P)(π/4)(G²−d²)

Therefore,

F_{S}=F_{R}=X(P)(π/4)(G²−d²)

From FIG. 3(a), it is observed that the axial force in the nozzle neck 33 is independent of the initial preload in the restraining rod 27 and structural frame 34 and is exactly equal to the end pressure thrust,

F_{N}=P(π/4)(D²−d²).

The axial tensile pressure thrust force is reacted by the nozzle neck 33 and the reacting force, F_{R}, is balanced by reacting through the structural frame 34 as F_{S} into the external vessel (pipe) wall as at 10. The membrane circumferential (hoop) stress in the nozzle neck 33 away from any discontinuities is equal to P D/(2 t) where “t” is the nozzle neck thickness. This is the same as in a full system pressure test.

Therefore the design in FIG. 3 is able to exactly match the circumferential pressure stress during a full system pressure test. Also, the nozzle neck axial tensile force, which is applied to the weld 35 joining the nozzle apparatus and vessel 10 (pipe) is tensile and approximately equal to the axial tensile force during a full pressure test which is=P(π/4)D².

Note that the total shear force at the nozzle weld 35 is equal to F_{N} plus the small force due to the pressure acting over the small annular area from the nozzle inside diameter to the weld diameter. This small additional pressure force is exactly the same as in a full system pressure test.

It should be further noted that for typical bolt strength materials the rod diameter “d” is such that the pressure thrust area is within about 10% of the nozzle inside area. The axial force in the structural frame 34 reacts the pressure thrust force, F_{S}=X(P)(π/4)(G²−d²), into the vessel (pipe) shell as at 10.

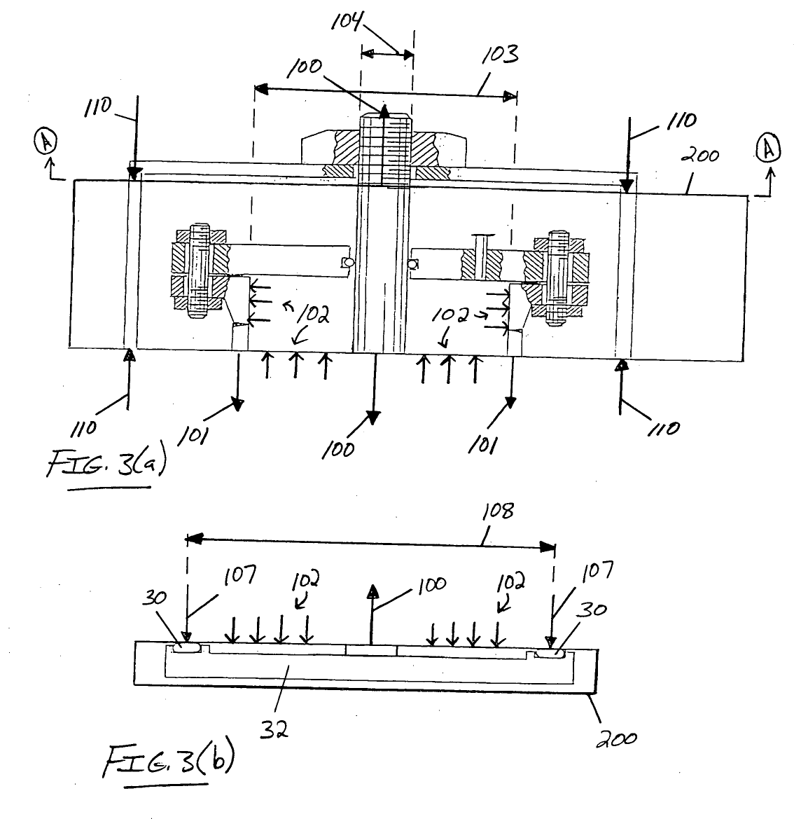

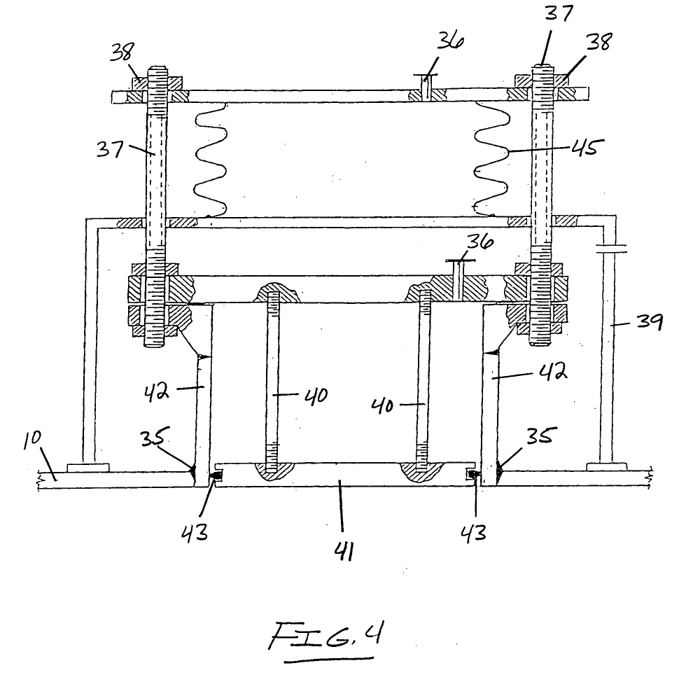

FIG. 4 is another means to react the pressure force with the outer vessel wall as at 10, as in FIG. 3, by using the thrust from an expansion joint bellows 45. The apparatus generally illustrated in FIG. 4 comprises pressure connections 36, oversized stud bolts 37, nuts 38, and a structural cylinder and end plate 39. The restraining rods 40 are attached to a pressure thrust restraining head 41. An O-ring or expandable (rubber) seal 43 interfaces intermediate the nozzle neck 42 and the pressure thrust restraining head 41.

The structural configuration generally illustrated in FIG. 4, as compared to the structure(s) in FIG. 3, has the added ability to independently control the axial pressure stress in the nozzle neck 42 in relation to the circumferential pressure stress. This would allow the nozzle to be pressure tested to include consideration of external loads and moments on the nozzle. FIGS. 4(a) and 4(b) are lower portion free body diagrams of the design generally illustrated in FIG. 4. Notably, the two restraining rods 40 shown in FIG. 4 have been replaced in FIGS. 4(a) and 4(b) with a single restraining rod 44 for simplicity.

Referencing FIGS. 4(a) and 4(b), the free body boundary is referenced at 200; the total axial force in the nozzle neck (42) “F_{N}” is referenced at 101; the total axial force in the restraining rod (44) “F_{R}” is referenced at 100; the total axial force in the structure “F_{S}” is referenced at 110; and the structural bolt force “F_{B}” is referenced at 109. The internal test pressure “P” is referenced at (vectors) 102; the nozzle inside diameter “D” is referenced at 103; and the restraining rod (44) outer diameter “d” is referenced at 104. The resulting equilibrium relation may be represented, as follows:

F_{N}+F_{R}−F_{S}−(P)(π/4)(D²−d²)=F_{B}−F_{S},

Noting that at Section A-A in FIG. 4(a),

F_{B}=F_{S}.

and during assembly,

F_{B}ⁱ=F_{S}ⁱ.

In this case a significant force is not required during assembly. During pressurization,

F_{N}=F_{S}=P(π/4)D_{eff}²,

(It should be noted, that if a different pressure thrust restraining head design is used, such as in FIG. 3, a force balance such as shown in FIG. 3(b) would apply) where, D_{eff} (as referenced at 111) is the effective bellows diameter for the determination of the net bellows blowout force which accounts for the small axial stress in the bellows element 45 as more particularly illustrated in FIG. 4(c). D_{eff} is provided by the bellows manufacturer and has been validated by test.

Therefore the axial stress in the nozzle neck (42), F_{N}, may be exactly equal to the axial tensile force during a full pressure test, which is=P(π/4)D², or it may also be increased to test for imposed external loads, since the bellows diameter is a variable and the pressure in the bellows element 45 (which pressure functions to apply axial force only) may be independently controlled. The membrane circumferential (hoop) stress in the nozzle neck 42 away from any discontinuities is equal to P D/(2 t) where “t” is the nozzle neck thickness. This is the same as in a full system pressure test.

Therefore the design generally illustrated FIG. 4 is able to exactly match the circumferential pressure stress during a full system pressure test. Also, the nozzle neck axial tensile stress, which is applied to the weld 35 joining the nozzle apparatus and vessel 10 (pipe) is tensile and may be equal to the axial tensile force during a full pressure test which is=P(π/4)D². The axial force in the structural frame 39 reacts the pressure thrust force, F_{S}=P(π/4)D_{eff}², into the vessel (pipe) shell as at 10.

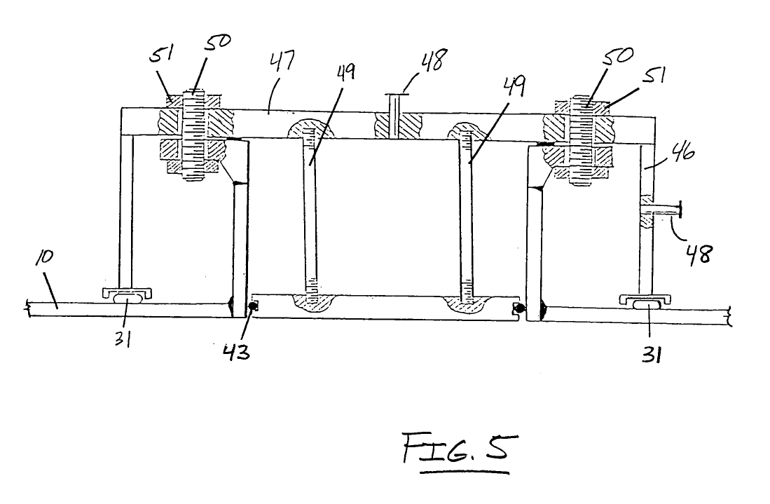

FIGS. 5(a) and 5(b) are free body diagrams of the test tool design otherwise generally depicted in FIG. 5. FIG. 5(a) depicts an upper or first portion and FIG. 5(b) depicts a lower or second portion. The overall design generally comprises a cylindrical housing 46, a (thick) blind flange 47, pressure connection(s) 48, restraining rods or pipes 49, an O-ring or expandable rubber seal 43, and an inflatable seal or bladder 31. Bolts 50 are secured by nuts 51 and metal-to-metal contact maintains a seal. It should be noted that FIG. 5(a) is shown with a single internal restraining rod 49 for simplicity.

Referring further to FIG. 5(a), the free body boundary is referenced at 200; total axial force in the nozzle neck (53) “F_{N}” is referenced at 101; the total axial force in the structure “F_{S}” is referenced at 110; the total axial force in the restraining rod (49) “F_{R}” is referenced at 100; the nozzle outside diameter “Dₒ” is referenced at 105; the nozzle inside diameter “D” is referenced at 103; the inside diameter of the cylindrical housing (46) “D_{S}” is referenced at 106; the restraining rod outside diameter “d” is referenced at 104; and the internal test pressure “P” is referenced at vectors 102.

Note that the vectors at 102′ inside the nozzle are enhanced in magnitude relative to the vectors 102 outside the nozzle. The magnitude difference is meant to depict the inside nozzle pressure “2P” relative to the outside nozzle pressure “P”. The inside nozzle pressure “2P” is referenced at 102 prime or 102′. The equilibrium relation may thus be given as follows:

F_{S}+(P)(π/4)(D_{S}²−Dₒ²)+(2P)(π/4)(D²−d²)=F_{R}+F_{N}

From FIG. 4(b):

F_{R}=2P(π/4)(D²−d²)

Therefore:

F_{N}=F_{S}+P(π/4)(D²−d²)

Referring to FIG. 5(b), the free body boundary is referenced at 200; the total axial force in the nozzle neck 53 “F_{N}” is referenced at 101; the total axial force in the structure “F_{S}” is referenced at 110; the nozzle outside diameter “Dₒ” is referenced at 105; the inside diameter of the cylindrical housing (46) “D_{S}” is referenced at 106; and the internal test pressure “P” is referenced at vectors 102. For the initial assembly condition the inflatable seal or bladder 31 is pressurized to achieve a compressive force, F_{S}ⁱ, in the cylindrical housing 46 at least equal to the axial pressure thrust force during the pressure test.

Referring again to FIG. 5(b), F_{S}ⁱ is reacted by the outer vessel wall 10. Alternatively, as in FIG. 2(a), structural bolts 50 may be tightened to achieve a compressive force in the cylindrical housing 46 at least equal to the axial pressure thrust force during the pressure test. In this case the axial pressure thrust during the pressure test is now the pressure over the outer annulus 54 defined as that area between the outside of the nozzle wall 53 and the inside of the outer cylindrical housing 46. Essentially, the same discussion on assembly stress as presented for FIG. 2 applies here also.

Therefore as before for the assembly condition,

F_{S}ⁱ=X(P)(π/4)(D_{S}²−Dₒ²), where X is a factor greater than 1.0.

Also,

F_{N}ⁱ=F_{S}ⁱ and

F_{N}=F_{N}ⁱ+the change in F_{N} during pressurization.

The gasket (seal) location is at F_{S} (110) and, as before, it may be assumed that the load will decrease by the pressure thrust. Note that if the inflatable seal 31 is used and it is flexible, the pressure thrust may be carried by the stiffer nozzle neck 53 resulting in a higher axial stress than in the following derivation. This derivation would be more applicable to the FIG. 2 design where the initial preload is applied by the structural bolts and metal-to-metal contact where the cylindrical housing contacts the vessel (pipe) outer surface.

F_{S}=F_{S}ⁱ+change in load during pressurization=(X−1)(P)(π/4)(D_{S}²−Dₒ²).

F_{N}=F_{S}+(P)(π/4)(D_{S}²−Dₒ²)=X(P)(π/4)(D_{S}²−Dₒ²).

Since the desired axial thrust force during the pressure test is P(π/4)D² the outer annulus 54 must be sized to give the desired force. The preload and annular thrust force for the FIG. 2 design could actually apply a stress greater than desired and yield the nozzle. There will be a high degree of variability in the preload force with the FIG. 2 design, because it is a controlled displacement vs. a controlled load. The FIG. 5 design with inflatable seal 31 will provide more accurate control of the preload force, “F_{S}ⁱ” and force “F_{S}” during pressurization.

The membrane circumferential (hoop) stress “Sₕₒₒₚ” in the nozzle neck away from any discontinuities is equal to:

Sₕₒₒₚ=(2P)D/(2 t)−P Dₒ/(2 t) where “t” is the nozzle neck thickness.

Sₕₒₒₚ=P(2D−Dₒ)/(2 t)

This stress is tensile as in a full system pressure test and is approximately equal to P D/(2 t), the same as in a full system pressure test. Therefore the design in FIG. 5 is able to approximately match the circumferential pressure stress during a full system pressure test. Also, the nozzle neck axial tensile stress, which is applied to the weld 35 joining the nozzle and vessel (pipe) 10 is tensile and may be made to equal to the axial tensile force during a full pressure test. Since the desired axial thrust force during the pressure test is P(π/4)D² the outer annulus 54 must be sized to give the desired force. The axial force in the cylindrical housing, F_{S}, is reacted by the external vessel (pipe) shell as at 10.

If the nozzle internal pressure during the test in FIG. 5(a) is defined as P₁ and the external pressure is defined as pressure P₂, the pressures P₁ and P₂ can be derived such that the hoop stress during the test is equal to P D/(2 t) and the axial force in the nozzle neck is equal to P(π/4)D². It should be noted that for the FIG. 5 design, the axial pressure thrust in the nozzle is carried by the external vessel (pipe) wall 10 as a distributed pressure force, vs. a concentrated load in the outer cylindrical housing 46. The nozzle external pressure to achieve an axial force in the nozzle neck 53 is currently used in the industry, however the addition of the internal pressure thrust restraining head 32, the method of applying pressures P₁ and P₂, and the method of controlling force F_{S} by use of inflatable seal 31, is the invention described here.

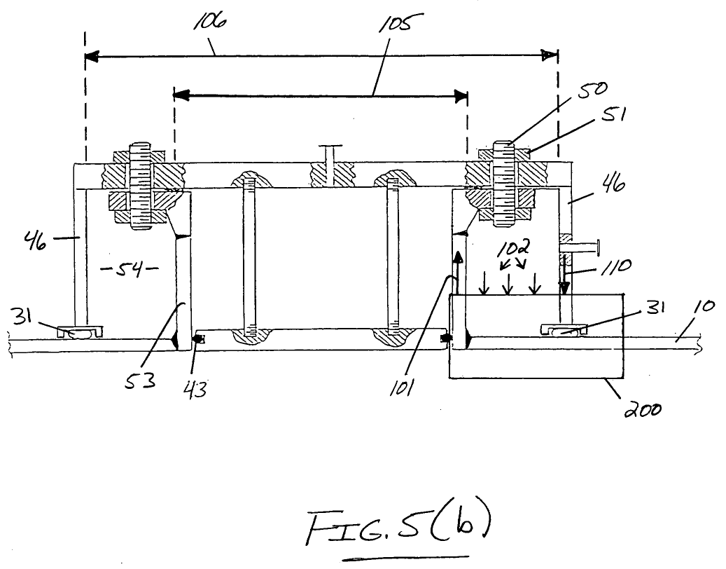

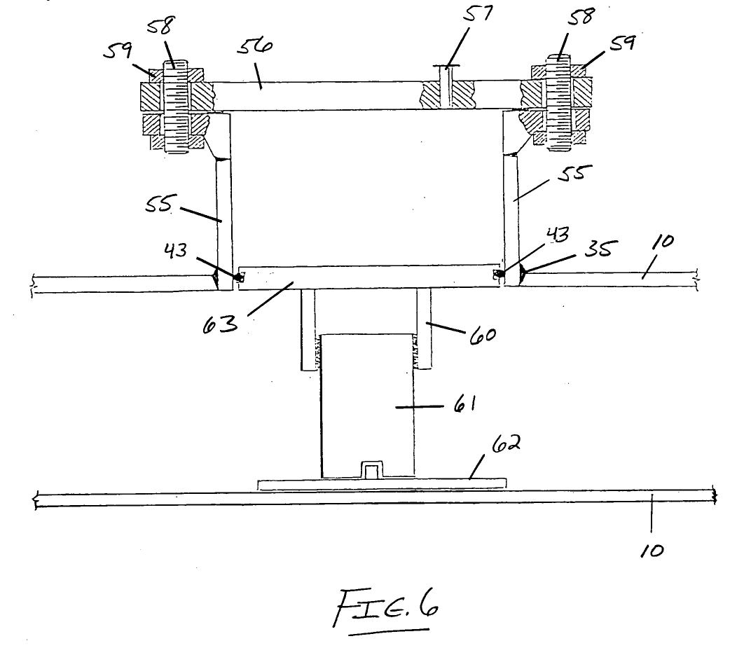

FIGS. 6(a) and 6(b) are free body diagrams of the test tool design otherwise depicted in FIG. 6. FIG. 6(a) depicts an upper or first portion and FIG. 6(b) depicts a lower or second portion. The test tool design depicted in FIG. 6 comprises a blind flange 56; a pressure connection 57; nozzle neck 55; bolts 58; nuts 59; an O-ring or expandable rubber seal 43; an internal pressure restraining head 63; and a pipe/vessel assembly. The pipe/vessel assembly comprises a threaded shaft housing 60, a threaded adjustable shaft 61, and a bearing plate 62. Said pipe/vessel assembly is structurally located intermediate the pipe/vessel wall boundaries as at 10.

Referencing FIG. 6(a), the free body boundary is referenced at 200; the total axial force in the nozzle neck (55) “F_{N}” is referenced at 101; the nozzle inside diameter “D” is referenced at 103; and the internal test pressure “P” is referenced at vectors 102. The equilibrium relation may be represented as follows:

F_{N}=(P)(π/4)(D²)

Referencing FIG. 6(b), the free body boundary is referenced at 200; the total axial force in the structure “F_{S}” is referenced at 110; the nozzle inside diameter “D” is referenced at 103 (or in the more general case where the pressure seal is at the gasket seal diameter “G” as at 108); and the internal test pressure “P” is referenced at vectors 102. The equilibrium relation may be represented as follows:

F_{S}=(P)(π/4)(D²), or more generally,

F_{S}=(P)(π/4)(G²)

For the initial assembly condition the internal pressure restraining head 63, with shaft housing 60 and adjustable shaft 61 are inserted in the nozzle neck 55 and bear against the vessel (pipe) wall 10 opposite to the nozzle. In this case no preload is required since the O-ring pressure restraining seal 43 is on the outside diameter of the pressure thrust restraining head 63 and the seal is pressure activated or “self sealing.” In this case F_{S}ⁱ=0. However if a pressure thrust plate that seals outside of the nozzle weld (such as is shown in FIG. 3) is used then the adjustable shaft 61 must be used to provide an initial axial pressure thrust assembly force greater than the axial pressure thrust force during the pressure test. In this case F_{S}ⁱ=X(P)(π/4)G².

FIG. 6(c) shows a variation of this latter arrangement and free body diagram as at FIG. 6(d) whereby hydraulic fluid may be used to pressurize the adjustable shaft 66 intermediate an upper or first plate 67 and a lower or second plate 68 so as to apply the initial sealing force, although it should be noted that a mechanical threaded connection could also be used to apply initial force. A hydraulic fluid inlet 64 and a hydraulic pressure chamber 65 are generally referenced. The total axial force in the structure “F_{S}” is referenced at 110; the reaction force at the gasket seal location “F_{G}” is referenced at 107 (see seal 70); and the internal test pressure “P” is referenced at vectors 102.

Referring to FIG. 6(b), F_{S} and F_{S}ⁱ are reacted by the vessel (pipe) wall 10 opposite to the nozzle. During the test the nozzle is pressurized and the applied forces are as follows:

In the first case (FIG. 6(b)):

F_{S}=(P)(π/4)D²

In the second case (FIG. 6(c)):

F_{S}=X(P)(π/4)G²

In both cases,

The membrane circumferential (hoop) stress in the nozzle neck away from any discontinuities is equal to P D/(2 t) where “t” is the nozzle neck thickness. This is the same as in a full system pressure test. Therefore the test tool design generally depicted in FIG. 6 is able to exactly match the circumferential pressure stress during a full system pressure test. Also, the nozzle neck axial tensile stress, which is applied to the weld 35 joining the nozzle as at 55 and vessel (pipe) as at 10 is tensile and exactly equal to the axial tensile force during a full pressure test which is=P(π/4)D².

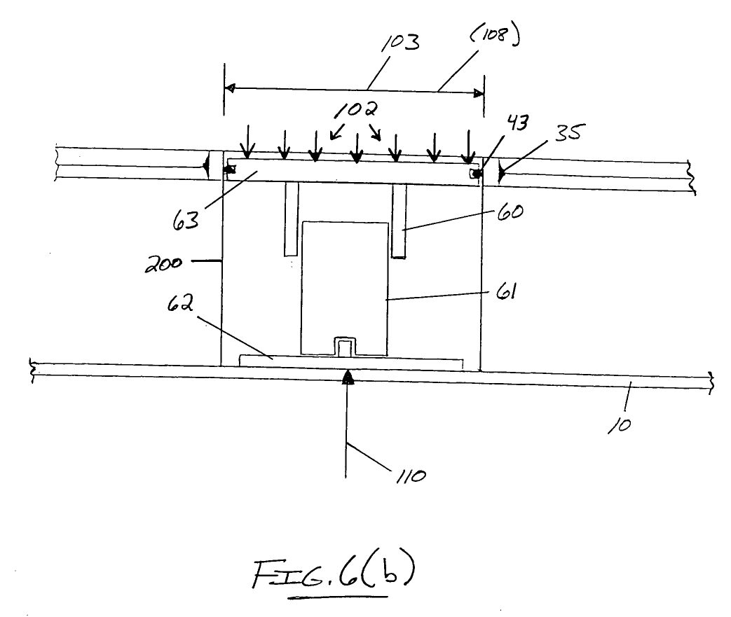

Further referencing U.S. Patent Application Publication No. 2007/0248202 A1, it is noted that this Patent Application describes a nozzle testing apparatus and method. FIG. 2 of this disclosure is re-presented herein as FIG. 7. FIGS. 7(a) and 7(b) are free body diagrams of the apparatus otherwise depicted in FIG. 7. It may be seen that the FIG. 7 prior art device is essentially a modification of the FIG. 1 prior art device of this application.

Referencing FIG. 7, the apparatus comprises a nozzle neck or stem as at 80, an inner pipe as at 81 (that opens to the atmosphere as at 84); an outer O-ring type gasket as at 82; and an inner O-ring type gasket as at 83. Further referencing FIG. 7(a), the free body boundary is referenced at 200; the outer diameter of the pipe (81) “d” is referenced at 112, the inner diameter of the nozzle neck (80) “D” is referenced at 113; the total axial force in the nozzle neck (80) “F_{N}” is referenced at 101; the total axial force in the pipe (81) “F_{R}” is referenced at 100; and the internal test pressure “P” is referenced at vector 102.

Further referencing FIG. 7(b), the free body boundary is referenced at 200; the outer gasket (82) seal diameter “G” is referenced at 114; the inner gasket (83) seal diameter “d_{G}” is referenced at 115; the reaction force at the gasket (82) seal location “F_{G}” is referenced at 107; the total axial force in the restraining pipe (81) “F_{R}” is referenced at 100; and the internal test pressure “P” is referenced at vectors 102. Thus,

F_{R}=F_{G}+(P)(π/4)(G²−d_{G}²)

For the initial assembly condition,

F_{R}ⁱ=F_{G}ⁱ=(X)(P)(π/4)(G²−d_{G}²) where X>1.0

Assuming all of the pressure load relieves F_{G},

F_{G}=(X−1)(P)(π/4)(G²−d_{G}²)

F_{R}=(X)(P)(π/4)(G²−d_{G}²)

Thus,

F_{N}=F_{R}−(P)(π/4)(D²−d²)

F_{N}=(X−1)(π/4)(D²−d²)

for X>1.0, F_{N} is in compression.

It will thus be understood that the device shown in FIG. 7 provides a hole in the nozzle so that a 2 man crew with one man on the outside of the vessel and one man on the inside of the vessel can communicate. The axial stress in the nozzle is still compression as shown above. Further, the technical aspects of the pressure test have not changed. The pressure thrust restraining head in FIG. 4 of the present invention, for example, avoids the inside-outside access problem by only requiring access to the outside of the vessel.

FIG. 12 of U.S. Patent Application Publication No. 2007/0248202 is further re-presented in this application as FIG. 8. The prior art device generally shown in FIG. 8 comprises a pipe 90; a nozzle neck 91; a jack bolt 92; a bearing ring 97; an outer gasket seal as at 94; and an inner gasket seal as at 95. The pipe 90 comprises a flange 96, and the bearing ring 97 comprises a perpendicularly extending flange 93, which extends away from the nozzle neck 91. The vessel wall is referenced at 10. Three free body boundaries are referenced at 201, 202, and 203.

With regard to the boundary 201, an inside diameter of flange (93) “D₉₃” is referenced at 116; the outside diameter of the pipe (90) “d” is referenced at 118; the total axial force in the pipe (90) “F_{R}” is referenced at 100; the total axial force in the flange (93) “F₉₃” is referenced at 117; and the internal test pressure is referenced at vectors 102.

### Thus,

F_{R}+F₉₃=(P)(π/4)(D₉₃²−d²)

If pipe flange 96 is rigid,

F₉₃≈0, and

F_{R}≈(P)(π/4)(D₉₃²−d²).

If the respective stiffness in pipe 90 and the load path through perpendicular extending flange 93 are approximately equal, then

F_{R}≈F₉₃, and thus,

F_{R}=½(P)(π/4)(D₉₃²−d²)

With regard to the boundary 202, an inside diameter of neck (91) “D” is referenced at 120; the outside diameter of the pipe (90) “d” is referenced at 118; the total axial force in the pipe (90) “F_{R}” is referenced at 100; the total axial force in the neck (91) “F_{N}” is referenced at 119; the total axial force in bolts (92) is referenced at 204; and the internal test pressure is referenced at vector 102. Thus,

F_{N}+F_{R}=F_{S}+(P)(π/4)(D²−d²)

If pipe flange 96 is rigid,

F_{N}=F_{S}−(P)(π/4)(D₉₃²−D²)

### If F_{R}≈F₉₃,

F_{N}=F_{S}−(P)(π/4)(½D₉₃²−D²−½d²)

The boundary 203 may be essentially described by reference to free body boundary 203 in FIG. 7(b) and the descriptions thereof set forth hereinabove.

The prior art arrangement generally illustrated in FIG. 8 attempts to achieve both hoop and axial tension in the nozzle neck 91. The axial force is due to the jack bolts 92. However, jack bolts 92 (or any jacking means) apply a displacement to provide the axial stress. This is a secondary stress, not a primary stress as required. Note that depending on the relative stiffness of the components the jack bolts 92 may need to apply more than the full axial pressure thrust force (P(π/4)D²) during initial assembly. Therefore this design does not duplicate a full system pressure test.

The method of testing nozzle or branch connection described hereinabove essentially involves testing using a fluid (liquid or gas) by a means where the nozzle is subjected to hoop (circumferential) tension and axial tension, the magnitude of which is approximately equal to that achieved in a full system pressure test. The inventive methodology isolate and pressure tests a nozzle in a vessel or pipe by using a device that is inserted from the outside of the nozzle to be tested using a pressure restraining head as at 32c, 41, or 63, although for certain applications a pressure restraining head (as at 32) may be placed from the inside of the vessel.

The test devices supporting the current methodology have the capability to react the axial pressure thrust force with a structural member or fluid pressure bearing on the external surface to a vessel or pipe or alternatively internal to the vessel or pipe bearing on the opposite wall of the pipe or vessel. The test devices may further internally pressurize the nozzle developing a hoop (circumferential) tension stress in the nozzle neck equal to that achieved in a full system pressure test. The stresses applied to the nozzle neck and attaching weld are primary stresses due to the applied pressure.

The common elements of the testing devices specified above are as follows: (1) the nozzle to be tested is internally pressurized; (2) the nozzle neck is subjected to a primary membrane⁽¹⁾ circumferential (hoop) stress approximately equal to (P D)/(2t); (3) the nozzle neck is subjected to a primary membrane⁽¹⁾ axial force approximately equal to P(π/4)D²; and (4) the axial pressure thrust force P(π/4)D² is reacted by the vessel (pipe) shell.

The primary membrane stress is as defined in the ASME Boiler and Pressure Vessel Code Section VIII Division 2. A primary membrane stress is the average value of stress across the thickness of the section under consideration developed by the imposed loading necessary to satisfy the simple laws of equilibrium of external and internal forces and moments. The basic characteristic of a primary stress is that it is not self limiting. Primary stresses which considerably exceed the yield strength will result in failure or at least gross distortion.

A secondary stress, by way of contrast, is a stress developed by the constraint of adjacent parts or by self constraint of a structure. The basic characteristic of a secondary stress is that it is self-limiting. Local yielding and minor distortions can satisfy the conditions which caused the stress to occur and failure from one application of the stress is not to be expected.

While the foregoing specifications and drawings are set forth in some detail, the specific embodiments described and illustrated thereby are to be considered as exemplifications of the principles of the underlying inventive methodology and are not intended to limit the same to the specific embodiments illustrated.

For example, it is contemplated that the present invention essentially comprises a method for testing a nozzle or nozzle neck connection, whereby the method comprises the steps of internally pressurizing a nozzle with a test pressure (P), subjecting the nozzle neck to a primary membrane circumferential stress; subjecting the nozzle neck to a primary membrane axial pressure thrust force; and reacting the axial pressure thrust force by a vessel shell, the vessel shell being welded to the nozzle neck.

The nozzle has a nozzle neck with an inside nozzle diameter (D) and a nozzle neck thickness (t). The primary membrane circumferential stress is thus approximately equal to (P)(D)/(2t), and the primary membrane axial pressure thrust force is approximately equal to (P)(π/4)(D²).

The primary membrane circumferential (hoop) stress may be independently controlled relative to the primary membrane axial pressure thrust force (as may be recalled from the discussion of the FIG. 3 device versus the FIG. 4 device).

Further, the step of internally pressurizing the nozzle with a test pressure (P) may be performed via an expansion joint bellows construction (See generally FIG. 4). The internal pressurization may thus be said to be optionally bellows controlled.

Other features include element 29 which element enables the simultaneous steps of providing minimal axial restraint while maintaining a pressure seal. The pressure thrust restraining head(s) may well function to restrain the test pressure and may be preferably sealed (as for example, via element 30). Element 31 may well enable the user to preload the otherwise sealed restraining head.

Stated another way, the present methodology essentially discloses a method for testing nozzle neck connection comprising the steps of internally pressurizing a nozzle neck with a test pressure; circumferentially and axially stressing the nozzle neck via the test pressure; and reacting the axially stressed nozzle neck via a vessel shell connected to the nozzle neck.

From the specifications, it will be observed that numerous variations and modifications may be effected without departing from the spirit and scope of the inventive methodology. It is to be understood that no methodological limitation with respect to the specific supporting embodiments illustrated herein is intended or should be inferred. It is, of course, intended to cover by the appended claims all such modifications as fall within the scope of the claims.

I claim:

1. A nozzle testing method, the nozzle testing method comprising the steps of:
internally pressurizing a nozzle with a test pressure (P), the nozzle having a nozzle neck, the nozzle neck having an inside nozzle diameter (D) and a nozzle neck thickness (t);
subjecting the nozzle neck to a primary membrane circumferential stress;
subjecting the nozzle neck to a primary membrane axial pressure thrust force; and
reacting the axial pressure thrust force by a vessel shell, the vessel shell being welded to the nozzle neck.

2. The method of claim 1 wherein the primary membrane circumferential stress is approximately equal to (P)(D)/(2t).

3. The method of claim 2 wherein the primary membrane axial pressure thrust force is approximately equal to (P)(π/4)(D²).

4. The method of claim 1 wherein the primary membrane circumferential hoop stress is independently controlled relative to the primary membrane axial pressure thrust force.

5. The method of claim 1 wherein the step of internally pressurizing the nozzle with a test pressure (P) is performed via an expansion joint bellows construction.

6. The method of claim 1 comprising the steps of simultaneously providing minimal axial restraint while maintaining a pressure seal.

7. The method of claim 1 comprising the step of restraining the test pressure via a sealed pressure thrust restraining head.

8. The method of claim 7 wherein the sealed pressure thrust restraining head is preloaded

9. A method of testing a nozzle, the method comprising the steps of:
pressurizing a nozzle with an internal test pressure (P), the nozzle having a nozzle neck with an inside nozzle diameter (D) and a nozzle neck thickness (t);
subjecting the nozzle neck to a circumferential stress;
subjecting the nozzle neck to an axial pressure thrust force; and
reacting the axial pressure thrust force via a vessel shell attached to the nozzle neck.

10. The method of claim 9 wherein the circumferential stress is approximately equal to (P)(D)/(2t).

11. The method of claim 10 wherein the axial pressure thrust force is approximately equal to (P)(π/4)(D²).

12. The method of claim 9 wherein the circumferential stress is independently controlled relative to the axial pressure thrust force.

13. The method of claim 9 wherein the step of pressurizing the nozzle with an internal test pressure (P) is bellows controlled.

14. The method of claim 9 comprising the step of restraining the test pressure via a sealed pressure thrust restraining head.

15. The method of claim 14 wherein the sealed pressure thrust restraining head is preloaded.

16. A method of testing nozzle neck connection, the method comprising the steps of:
internally pressurizing a nozzle neck with a test pressure;
circumferentially and axially stressing the nozzle neck via the test pressure; and
reacting the axially stressed nozzle neck via a vessel shell connected to the nozzle neck.

17. The method of claim 16 comprising the step of independently controlling the circumferentially and axially stressed nozzle neck.

18. The method of claim 16 wherein the step of internally pressurizing the nozzle neck is bellows controlled.

19. The method of claim 16 comprising the step of restraining the test pressure via a sealed restraining head.

20. The method of claim 19 wherein the sealed restraining head is preloaded.
